(19) United States
(12) Patent Application Publication
(10) Pub. No.: US 2014/0194167 A1
(43) Pub. Date: Jul. 10, 2014

(54) Mobile Device Case

(71) Applicant: GID Development Corporation, Yorba Linda, CA (US)

(72) Inventor: James E. Grimes, Yorba Linda, CA (US)

(73) Assignee: GID Development Corporation, Yorba Linda, CA (US)

(21) Appl. No.: 14/143,888

(22) Filed: Dec. 30, 2013

Related U.S. Application Data
(60) Provisional application No. 61/749,179, filed on Jan. 4, 2013.
(60) Provisional application No. 61/749,188, filed on Jan. 4, 2013.

(51) Int. Cl. H04M 1/02

(52) U.S. Cl. CPC H04M 1/0202
USPC 455/575.1

(57) ABSTRACT

Modular mobile device cases are provided. The cases have a main body portion having at least one groove sized and dimensioned to accept a portion of at least one of a design insert and a cover insert. Contemplated kits can include at least one of (1) a plurality of inserts that can be interchangeably installed in the groove, and (2) a plurality of bands or streamers that can be interchangeably installed in a recess of a main body structure side wall to allow users to modify a design of a case without purchasing an entirely new case.

This application claims the benefit of priority of U.S. Provisional Application Nos. 61/749,179 and 61/749,188, each filed on Jan. 4, 2013. These applications and all publications cited herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is mobile device cases.

### BACKGROUND

The following description includes information that may be useful in understanding the present invention. It is not an admission that any of the information provided herein is prior art or relevant to the presently claimed invention, or that any publication specifically or implicitly referenced is prior art.

Many consumers invest in cases to protect their valuable mobile devices. These mobile device cases are often very expensive, and replaced numerous times throughout the device's life because of breakage, or because the consumer wants a different color case, a different design attribute, or other reason.

One company that attempts to solve some of the problems described above is Skech™ Sketch provides iPhone 4/4s cases under the name Kameo™ having a removable back panel that is placed under the main body structure of the case. This allows users to change a back panel of the case. Unfortunately, the Kameo case is inconvenient for users as it apparently requires that the entire main body structure be removed from device in order to replace the back panel. Furthermore, the Kameo apparently only allows the back panel of the case to be changed.

Thus, there is still a need for improved mobile device cases that is modular in nature and easy to modify.

### SUMMARY OF THE INVENTION

The inventive subject matter provides apparatus, systems and methods in which a mobile device case comprises a groove sized and dimensioned to removably receive one or more substantially planar inserts that at least one of exposes a design or comprises a design. Cases of the inventive subject matter advantageously allow a user to modify a design of his or her case by switching out one or more substantially planar inserts (e.g., design inserts, cover inserts, etc.) streamers or bands, rather than by replacing an entire case, or a relatively expensive component of the case.

In some aspects of the inventive subject matter, a mobile device case comprises a main body structure having a top portion and a bottom portion that removably mate with one another. As used herein, the term “removably mate” is used broadly to cover various embodiments, including for example, those wherein a top portion and a bottom portion removably couple or lock, and those wherein a top portion and a bottom portion are positioned adjacent (e.g., sharing a common boundary) to one another.

The main body structure could comprise a side wall that is sized and dimensioned to surround a side wall or a perimeter of a mobile device (e.g., cell phone, tablet, laptop computer, personal digital assistant, etc.). The side wall could advantageously comprise a recess sized and dimensioned to receive a band that could be used to keep the top and bottom portions of the main body structure in a closed configuration. Additionally or alternatively, the main body structure could comprise a back portion having a back wall and a groove, wherein the groove is sized and dimensioned to receive at least a portion of a flange of a substantially planar insert. In some embodiments, the substantially planar insert could comprise a shape that is substantially the same as the back wall.

It should be appreciated that a substantially planar insert could comprise any suitable insert wherein at least 90% of a non-perforated top or bottom surface is flat, including for example, a cover insert (e.g., a transparent or substantially transparent cover), a photo or design insert (e.g., a paper insert having an image or other design printed thereon), or even a perforated insert.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an embodiment of a mobile device case of the inventive subject matter in an open configuration.

FIG. 2 illustrates an embodiment of a mobile device case of the inventive subject matter in a closed configuration.

FIG. 3 illustrates a rear perspective view of an embodiment of a mobile device case of the inventive subject matter.

FIG. 4 is a cross-sectional view of an embodiment of a main body structure of the inventive subject matter.

FIGS. 5A-5C illustrates several embodiments of substantially planar inserts of the inventive subject matter.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

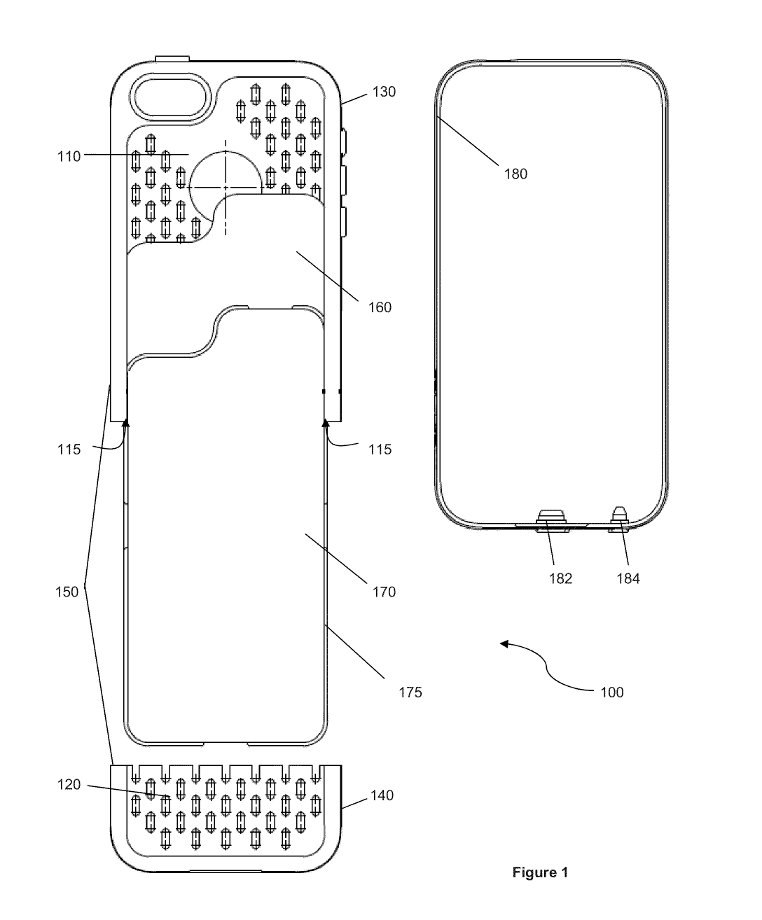

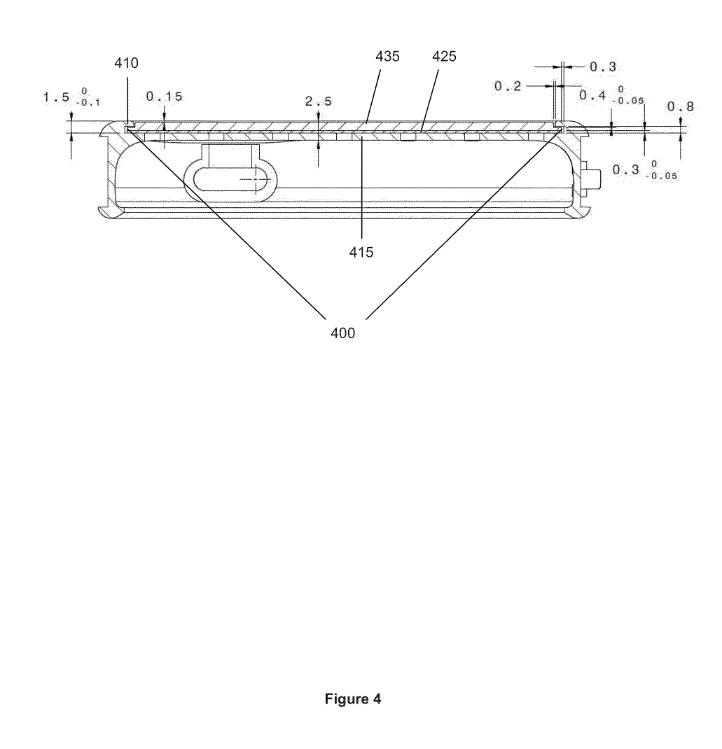

FIG. 1 illustrates a rear view of an embodiment of a mobile device case 100 of the inventive subject matter in an open configuration. Case 100 comprises a main body structure 150 composed of a top portion 130 and a bottom portion 140. Each of the top and bottom portions comprise a back wall, 110 and 120, respectively, which act as one side of a groove 115 or rail that is sized and dimensioned to receive at least one of (1) an entire or partial perimeter of photo insert 160, and (2) an entire or partial flange 175 of cover insert 170. A second side of the groove comprises a lip parallel or substantially parallel to the back wall (see e.g., FIG. 4). Case 100 also comprises a band 180 having first tab 182 and second tab 184. Band 180 is configured to wrap around a portion of a side wall of the main body structure, for example, by fitting within a recess of the side wall to thereby form a smooth surface (as defined below). First and second tabs 182 and 184 are flexible tabs having protrusions that fit through apertures of the main body structure. Such tabs advantageously can protect a port of a mobile device (e.g., a port for a battery charger, a headphone, an auxiliary cord, etc.).

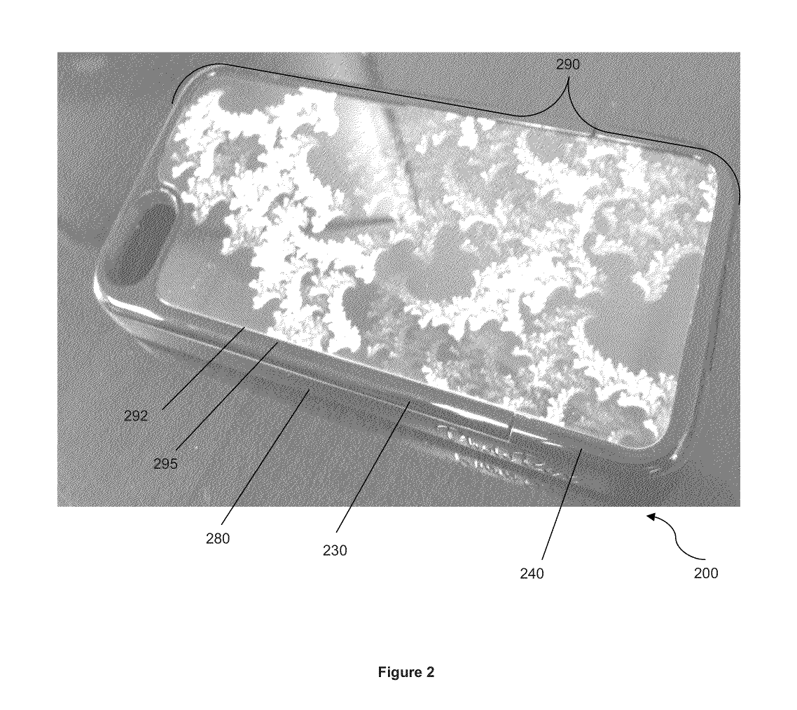

FIG. 2 is a rear perspective view of another embodiment of a mobile device case 200, case 200 being in a closed configuration. In the closed configuration, top portion 230 and bottom portion 240 are adjacent one another, and kept in such a position via band 280, which wraps around a side wall perimeter of the top and bottom portions. As illustrated, band 280 is sized and dimensioned such that when it is placed within a recess of the main body structure's perimeter side wall, it is flush (or approximately flush) with the side wall and creates a smooth surface (as defined below) that lacks substantial bumps or depressions. Back portion 290 comprises at least one of a top to bottom and a side to side horizontal midline that is smooth (i.e., an edge of a first component (e.g., the insert(s) 292) and an edge of a second component (e.g., lip 295 of back portion 290) align within 0.3 mm).

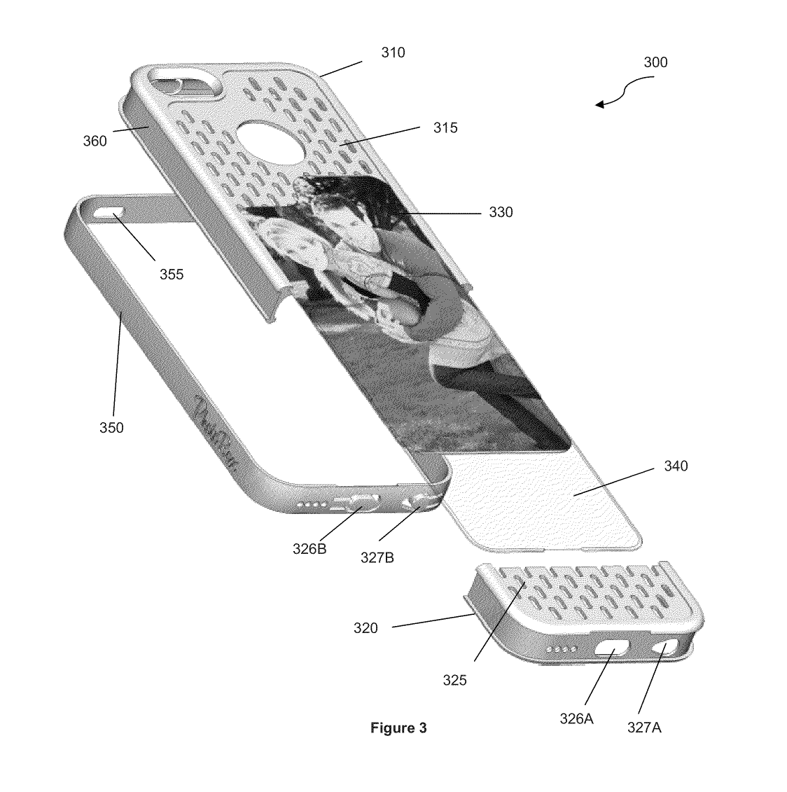

FIG. 3 illustrates yet another embodiment of a mobile device case 300 of the inventive subject matter. Case 300 comprises a top portion 310 having a back wall 315, and a bottom portion 320 having a back wall 325. An astute reader should appreciate that when case 300 is in a closed configuration, back wall 315 and back wall 325 could appear to be a single piece of material. It should also be appreciated that some mobile device cases could comprise a single back wall that extends from one of the top and bottom portions.

Each of top and bottom portions 310 and 320 comprise a groove that extends from a left side of the respective portion to a right side of the respective portion. In some preferred embodiments, the top portion 310's groove is shaped substantially identically to a top perimeter portion of a photo insert 330 or a cover insert 340 such that the top perimeter portion of the photo insert 330 or cover insert 340 fits into top portion 310's groove. Additionally or alternatively, the bottom portion 320's groove could be shaped substantially identically to a bottom perimeter portion of the photo insert 330 or the cover insert 340 such that the bottom perimeter portion of the photo insert 330 or the cover insert 340 fits into bottom portion 320's groove.

Case 300 could also comprise a side wall having a recess 360 that is sized and dimensioned to receive band 350, which could wrap around a perimeter of case 300 in a closed configuration such that top portion 310 and bottom portion 320 are kept adjacent to one another (until the band is removed) with at least one of photo insert 330 and cover insert 340 slid underneath the grooves therein. Band 350 could include a third aperture 355 sized and dimensioned to receive a third tab located on the main body structure (e.g., top portion 310, etc.), and first tab 326B and second tab 327B, which could be sized and dimensioned to fit at least partially through first aperture 326A and second aperture 327A of main body structure (e.g., bottom portion 320, etc.). It should be appreciated that any component of a mobile device case of the inventive subject matter could comprise any suitable number of apertures and corresponding tabs (e.g., 1, 2, 3, 4, 5, or even 10 or more, etc.).

FIG. 4 is a cross-sectional view of an embodiment of a mobile device case of the inventive subject matter, showing possible dimensions thereof. As illustrated, back wall 415 and lip 410 define a groove 400 that is a closed loop shaped similarly to a corresponding insert (e.g., non-circular). While not wishing to limit the scope of the inventive subject matter, it is contemplated that in some embodiments, a mobile device case will have some or all of the following dimensions: (1) a groove 400 having a thickness of between 0.6 and 1 mm, more preferably between 0.7 and 0.9 mm, and even more preferably approximately 0.8 mm; (2) a groove 400 and lip 410 combination having a thickness of between 1.1 and 1.9 mm, more preferably between 1.3 and 1.7 mm, and even more preferably approximately 1.5 mm; (3) a back wall 415 having a thickness at a mid-portion of between 0.8 and 1.2 mm, more preferably between 0.9 and 1.1 mm, and even more preferably approximately 1 mm; (4) a photo insert 425 having a thickness of between 0.2 and 0.4 mm, more preferably approximately 0.3 mm; (5) a cover insert 435 having (a) a mid-portion thickness of between 1 and 1.5 mm, more preferably between 1.1 and 1.3 mm, and even more preferably approximately 1.2 mm, and (b) a flange thickness of between 0.2 and 0.6 mm, more preferably between 0.3 and 0.5 mm, and even more preferably approximately 0.4 mm; (6) a cover insert having a side-to-side width (flange edge to flange edge) that is between 0.4 and 0.8 mm, more preferably between 0.5 and 0.7 mm, and even more preferably approximately 0.6 mm less than a side-to-side width between left and right sides of groove 400; and (7) a cover insert having a non-flange width that is between 0.1 and 0.6 mm, more preferably between 0.3 and 0.5 mm, and even more preferably approximately 0.4 mm less than a side-to-side width between left and right sides of lip 410.

While the above lists some preferred dimensions of some mobile device cases of the inventive subject matter, also contemplated are grooves having a thickness of greater than 1 mm, including for example, between 1-10mm, 6-10 mm, between 7-9 mm, or approximately 8 mm. Additionally or alternatively, a groove and lip combination could have a thickness of greater than 1.9 mm, including for example, between 2-19 mm, between 11-19 mm, between 13-17 mm, or approximately 15 mm. Additionally or alternatively, a back wall could have a thickness at a mid-portion that is greater than 1.2 mm, including for example, between 1.3-12 mm, between 8-12 mm, between 9-11 mm, or approximately 10 mm. Additionally or alternatively, a photo insert could have a thickness that is greater than 0.4 mm, including for example, between 0.5-4 mm, between 2-4 mm, between 2.5-3.5 mm, or approximately 3 mm. Additionally or alternatively, a cover insert could comprise a mid-portion thickness greater than 1.5 mm, including for example, between 1.6-15 mm, between 10-15 mm, between 11-13 mm, or approximately 12 mm. Additionally or alternatively, a cover insert could comprise a flange thickness of greater than 0.6 mm, including for example, between 0.7-6 mm, between 2-6 mm, between 3-5 mm, or approximately 4 mm. Additionally or alternatively, a cover insert could have a side-to-side width that is more than 0.8 mm less than a side-to-side width between left and right sides of a groove (e.g., 0.9-5 mm, 1-2 mm, etc.). Additionally or alternatively, a cover insert could have a non-flange width that is more than 0.6 mm less than a side-to-side width between left and right sides of a lip (e.g., 0.7-5 mm, 1-2 mm, etc.).

Viewed from another perspective, it is contemplated that a thickness ratio between (1) a groove, and (2) a combination of photo insert and cover insert could be approximately 10:9, approximately 10:8, approximately 10:7; and more preferably approximately 8:7. In some embodiments where only one insert is used, it is contemplated that a thickness ratio between (1) a groove, and (2) the insert could be approximately 2:1, approximately 10:9, approximately 10:8, approximately 10:7 or approximately 8:7. Some preferred dimensions allow for a smooth or flush surface where an insert (e.g., cover insert, etc.) and a main body structure meet. Additionally or alternatively, an insert could comprise (1) a mid-portion (non-flange portion) thickness to (2) flange thickness ratio of between approximately 2:1 and approximately 4:1, preferably approximately 3:1 (e.g., approximately 1.2 mm:approximately 0.4 mm, etc.). Additionally or alternatively, a ratio between (1) a thickness of a mid-portion of a cover insert and (2) a thickness of a photo or design insert could comprise a ratio of between approximately 3:1 and approximately 5:1, more preferably approximately 4:1 (e.g., approximately 1.2 mm:approximately 0.3 mm, etc.). However, it should be appreciated that all suitable dimensions and ratios are contemplated.

As used herein, the term “approximately” means within ±5%. For example, a thickness that is approximately 0.8 mm could comprise a thickness that is between 0.76 and 0.84 inclusive.

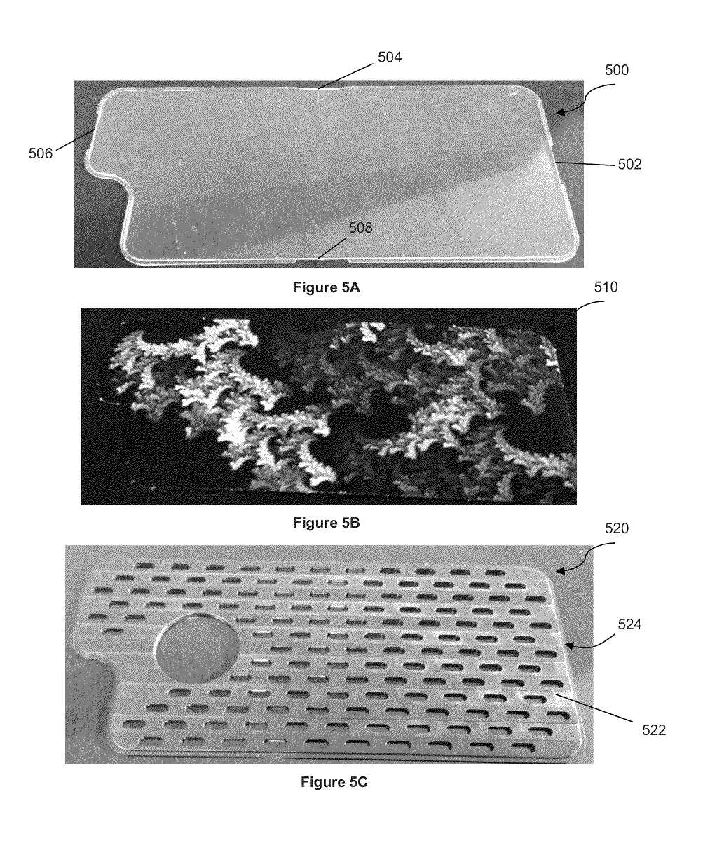

FIGS. 5A-5C shows three different substantially planar inserts of the inventive subject matter. As described above, a substantially planar insert could comprise any suitable size and shape, wherein at least 90% of a non-perforated top surface (e.g., 522) or bottom surface (e.g., 524) is flat (or substantially flat), as with insert 500, insert 510 and insert 520.

An insert of the inventive subject matter (e.g., 500, 510, 520) could advantageously be made of a plastic (e.g., ABS plastic, acrylic, etc.), a metal, a rubber, a fabric (e.g., polyester, cotton, etc.), photo paper (e.g., a high gloss photo paper, etc.), polyurethane, a combination thereof, or any other suitable material or materials. Where the insert is made of a material such as an acrylic, it is contemplated that the insert could be manufactured to comprise a flange having at least one gap (e.g., gap 502, gap 504, gap 506, gap 508, etc.) that allows the insert to be molded/cut/produced without any swirl marks or other imperfections. In some preferred embodiments, a flange of an insert could be between 9-14 mm, between 10-13 mm, between 11-12 mm, between 1.5-8.9 mm, between 0.9-1.4 mm, between 1.0-1.3 mm, or between 1.1-1.2 mm in length.

It should also be appreciated that an insert could comprise an image, a design, or perforations having a pattern, for example, to expose a color or other feature of a mobile device placed within the mobile device case.

Also contemplated are bands and streamers (for placing underneath an at least partially transparent band), which could have various design attributes and be replaced with one another, for example, as described in U.S. Provisional Application having Ser. No. 61/749,179. Additionally or alternatively, it is contemplated that an insert of the inventive subject matter could be designed, created or obtained using a mobile device case design system, for example, ones described in U.S. Provisional Application having Ser. No. 61/749,188.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A mobile device case for a mobile device comprising:
a main body structure having a top portion and a bottom portion that removably mate with one another;
wherein the main body structure comprises a side wall and a back portion;
wherein the side wall is sized and dimensioned to surround at least a portion of a perimeter of the mobile device; and
wherein the back portion comprises a back wall and a first groove, and wherein the first groove is configured to slidably receive at least a portion of a flange of a substantially planar insert.

2. The case of claim 1, wherein the side wall comprises a recess sized and dimensioned to receive a first band.

3. The case of claim 1, wherein the substantially planar insert comprises a cover insert having a mid-portion comprising a first thickness and a flange comprising a second thickness, and wherein the first thickness is at least two times greater than the second thickness.

4. The case of claim 1, wherein the first groove is further configured to slidably receive at least a portion of a design insert having a third thickness.

5. The case of claim 4, wherein the first thickness is approximately 1.2 mm, wherein the second thickness is approximately 4 mm, and wherein the third thickness is approximately 3 mm.

6. The case of claim 4, wherein the first thickness and the second thickness have a ratio of approximately 3:1, and wherein the first thickness and the third thickness have a ratio of approximately 4:1.

7. The case of claim 3, wherein the first thickness is approximately three times greater than the second thickness.

8. The case of claim 1, wherein the main body structure comprises polyurethane.

9. The case of claim 1, wherein the substantially planar insert comprises acrylic.

10. The case of claim 1, wherein the first groove is formed by a lip and a portion of the back wall.

11. The case of claim 1, wherein the first groove extends along a periphery of the back wall.

12. The case of claim 11, wherein the periphery of the back wall is substantially the same shape as a periphery of the substantially planar insert.

13. The case of claim 1, wherein the side wall comprises a plurality of protrusions, and wherein a first band comprises a plurality of apertures sized and dimensioned to receive the plurality of protrusions.

14. The case of claim 1, wherein the back portion comprises at least one of a top to bottom and a side to side horizontal midline that is smooth when the mobile device case is in a closed configuration.

15. The case of claim 1, wherein the flange of the substantially planar insert comprises at least one gap.

16. The case of claim 15, wherein the flange of the substantially planar insert comprises 4 gaps.
